(19) United States
(12) Patent Application Publication
(10) Pub. No.: US 2006/0179050 A1
(43) Pub. Date: Aug. 10, 2006

(54) Probabilistic model for record linkage

(76) Inventors: Phan H. Giang, Downingtown, PA (US); Sathyakama Sandilya, London (GB); William A. Landi, Devon, PA (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/255,660

(22) Filed: Oct. 21, 2005

Related U.S. Application Data
(60) Provisional application No. 60/621,247, filed on Oct. 22, 2004.

(51) Int. Cl. G06F 17/30

(52) U.S. Cl. 707/5

(57) ABSTRACT

A method for probabilistic record linkage includes providing a record pair comprising a plurality of fields, providing a plurality of scenarios, each scenario relating to a distribution of patterns among a plurality of attribute statuses, and comparing the record pair to determine a record difference. The method includes determining a probability of a status for each of a plurality of attributes based on the distance metric of the plurality of fields, wherein each field corresponds to a respective attribute, wherein the field is observable and the attribute is hidden, determining a probability of each scenario based on the probability of the status for each attribute and the Bayesian net representing the probabilistic model on the relationship between scenarios and attributes, and outputting a probability of duplication or non-duplication of the record pair determined from the probabilities of the plurality of scenarios.

This application claims priority to U.S. Provisional Application Ser. No. 60/621,247, filed on Oct. 22, 2004, which is herein incorporated by reference in its entirety.

### BACKGROUND OF THE INVENTION

1 . Technical Field

The present invention relates to database analysis, and more particularly to a system and method for record linkage.

2. Discussion of Related Art

Database record linkage is the problem of finding a list of sets of two or more database records that represent the same entity. Record linkage includes the problem of finding database records based on input search criteria. The former is often called the offline mode while the latter is the online mode.

Attribute values of an entity can vary over time, so the records belonging to the entity may contain correct but different values. Further, the recorded values are noisy versions of correct attribute values due to errors in the data entry and transmission processes. Note that the term “attribute” is reserved to denote a true but unobservable property of an entity or object. The term “field value” is reserved to denote value observed in a database record.

Existing systems consider only two possibilities (duplicate and non-duplicate) for a pair of records and do not consider more specific scenarios that correspond to certain patterns or relationship among attributes.

Consideration of only duplicate/non-duplicate scenarios may not be able to recognize specific well-defined patterns of duplication/non-duplication (e.g., two records of a woman that were created before and after she got married and changed her last name after the husband's as well as her residence address).

Therefore, a need exists for a system and method for a probabilistic model for record linkage.

### SUMMARY OF THE INVENTION

According to an embodiment of the present disclosure a computer-implemented method for probabilistic record linkage includes providing a record pair comprising a plurality of fields, providing a plurality of scenarios, each scenario relating to a distribution of patterns among a plurality of attribute statuses, and comparing the record pair to determine a record difference. The method includes determining a probability of a status for each of a plurality of attributes based on the distance metric of the plurality of fields, wherein each field corresponds to a respective attribute, wherein the field is observable and the attribute is hidden, determining a probability of each scenario based on the probability of the status for each attribute and the Bayesian net representing the probabilistic model on the relationship between scenarios and attributes, and outputting a probability of duplication or non-duplication of the record pair determined from the probabilities of the plurality of scenarios.

Comparing the record pair comprises comparing record values of the record pair field-wise or across fields.

Determining the probability of a status for each of the plurality of attributes includes providing a predefined error rate of data entering in a field, determining a distance metric between field values, and determining a probability of making i errors when entering m characters with the predefined error rate.

Each among a plurality of scenarios is characterized by a probability model on patterns of attribute statuses for example Bayesian net, conditional probabilities of attribute status given scenarios.

The probability of duplication is compared to a threshold, wherein the threshold corresponds to a significant probability of duplication.

The method further includes providing a graphical user interface, and displaying at least one of a scenario probability, a most probable scenario, a probability of duplication, and/or a probability that an entity is intended by an input search criteria.

The record pair is a search criteria for determining a target and a plurality of database records, the method further including determining for each database record the probability of duplication or non-duplication as a probability that the record is the target of the search criteria, and displaying in a graphical user interface the database records and a corresponding probability.

The record pair is a search criteria for determining a target and a plurality of database records, the method further including determining for each database record the probability of duplication or non-duplication as a confidence score corresponding to the search criteria, and displaying in a graphical user interface each database records and a corresponding confidence score.

According to an embodiment of the present disclosure, a computer-implemented method for probabilistic record linkage includes receiving a record pair, and outputting a probability of duplication between the record pair from an observation of field values of the record pair and noisy characteristics of the record pair.

The observation of field values is one of an edit distance, a soundex distance, a numerical distance, or a date distance between a pair of fields corresponding to the record pair, respectively.

The method further includes modeling the noisy characteristics of the record pair, which includes determining a probability of a difference between attribute values corresponding to the fields, and determining a probability of an error in the field values.

According to an embodiment of the present disclosure, a program storage device is provided readable by machine, tangibly embodying a program of instructions executable by the machine to perform method steps for probabilistic record linkage. The method includes providing a record pair comprising a plurality of fields, providing a plurality of scenarios, each scenario relating to a distribution of patterns among a plurality of attribute statuses, and comparing the record pair to determine a record difference. The method includes determining a probability of a status for each of a plurality of attributes based on the distance metric of the plurality of fields, wherein each field corresponds to a respective attribute, wherein the field is observable and the attribute is hidden, determining a probability of each scenario based on the probability of the status for each attribute and the Bayesian net representing the probabilistic model on the relationship between scenarios and attributes, and outputting a probability of duplication or non-duplication of the record pair determined from the probabilities of the plurality of scenarios.

### BRIEF DESCRIPTION OF THE DRAWINGS

Preferred embodiments of the present disclosure will be described below in more detail, with reference to the accompanying drawings:

FIG. 1 is an illustration a two level model of record linkage according to an embodiment of the present disclosure;

FIG. 2 is an illustration of a possible example of a Bayesian net representing relationship between scenarios and attribute statuses according to an embodiment of the present disclosure;

FIG. 3 is an illustration of attribute status and field values according to an embodiment of the present disclosure;

FIG. 4 is a flow chart of a method according to an embodiment of the present disclosure; and

FIG. 5 is a diagram of a system according to an embodiment of the present disclosure.

### DETAILED DESCRIPTION OF PREFERRED EMBODIMENTS

According to an embodiment of the present disclosure, a probabilistic model of record linkage determines probabilities of scenarios that exist for a pair of records. From the probabilities of scenarios, a probability that the pair of records are duplicative is determined. Ignoring probabilities of different scenarios may lead to a wrong and unintuitive decision.

A model of record linkage according to an embodiment of the present disclosure can handle many specific patterns of duplication/non-duplication (scenarios) and provides probabilities of those scenarios. Probability that the records are a duplicate pair could be determined for example by summing the probabilities of scenarios of duplication type.

The sum of probabilities of all scenarios, including duplication and non-duplication scenarios, totals 100%.

Users can use the probabilities of scenarios to make decisions, for example to do a trade-off between the risk of having duplication in the database and the amount of resource needed to clean up those duplicates.

A determined probability of duplication/non-duplication can be converted into score in a certain range (e.g. from 0 to 100) and be compared to a threshold, wherein the threshold corresponds to a significant probability of duplication/non-duplication. For example, a significant probability of duplication/non-duplication can indicate that further consideration of the records is needed.

One of ordinary skill in the art would recognize that other applications of a record linkage method according to an embodiment of the present disclosure can be implemented, for example, to determine records that match input search criteria (e.g., in an online mode).

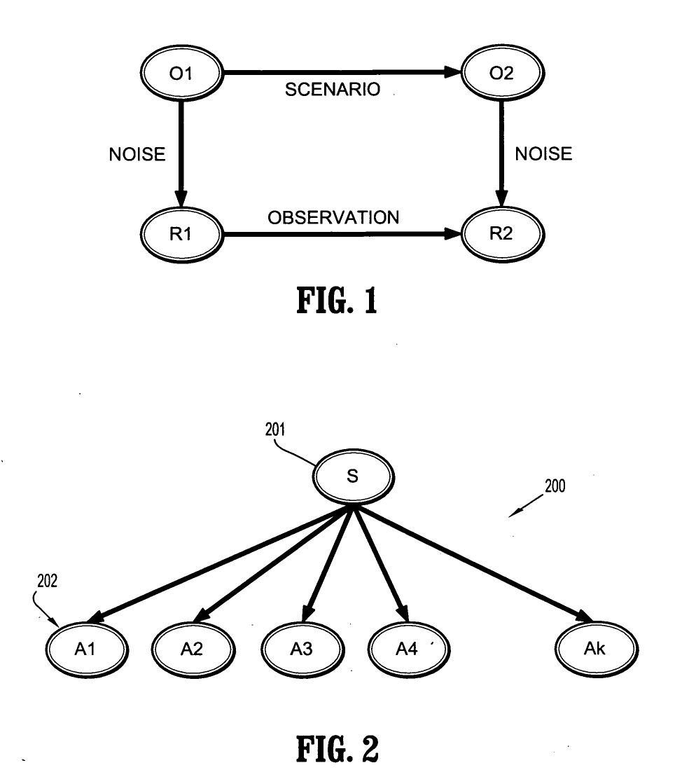

Referring to FIG. 1, a model for record linkage has two levels. At the first level are two records or entities with their attributes (O1 and O2). The attributes of the records are hidden (not observable). At the second level are two corresponding database records with their field values (R1 and R2). Field values are observable but they are noisy versions of attribute values. Different sources causing an observed difference in data fields of two records are recognized. These include a difference of attribute values (e.g., in a name field of two records, two different names corresponding to the same person due to marriage) and a difference due to noisy data (e.g., in the name field of two records, two different names corresponding to the same person due to a spelling error).

The (posterior) probabilities of scenarios are determined given the observation of field value differences, characteristics of noisy processes from attribute values to field values and characteristics of the scenario. The probabilities of the scenarios are summed to determine a total probability of duplication/non-duplication.

A scenario is a pattern among attributes; for example, “Siblings” (example of non-duplication) have the same address information, the same last name, and different first names. Thus, the scenario is described probabilistically by a set of conditional probabilities, e.g., the probability that the two siblings have the same address information, coupled with the probability that the two siblings have the same last name, and coupled with the probability that the two siblings have different first names.

Referring to FIG. 2, S 201 is the scenario variable. A1, A2, etc. (202) are Boolean variables for attribute status. Ai=0 indicates that the i^{th} attribute values are different, Ai=1 indicates that the i^{th} attribute values are the same. For example, in a record linkage problem to determine a probability of duplicate records (e.g., people), a scenario for “Siblings” can be written as {1,1,0}, representing attributes “Address Information,” “Last Name,” and “First Name” respectively.

Conditional probability Pr(Ai=1|S) is the probability that the values of attribute i are the same given the scenario S between two records. For example, if the attribute i is “Last Name” and the scenario S is “Sibling”, then P(Ai=1|S) is the probability that two records have the same last name.

As illustrated by FIG. 2, the relationship between scenario status and attribute status can be characterized by a Bayesian net 200. Other structures can be used to define the relationship between scenario and attribute statuses.

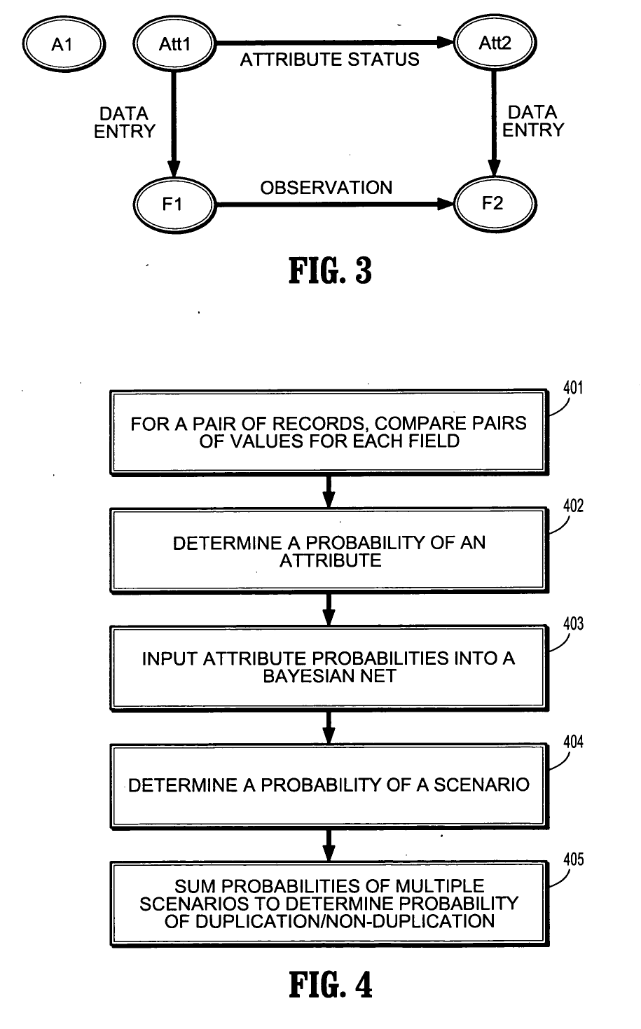

Referring to FIG. 3, a probability Pr(A) of each attribute status, e.g., Al=1 or 0, is determined from a field value comparison given the characteristics of noisy data entry that converts attribute values Att1, Att2 to field values F1, F2. The method for determination of Pr(Att1=Att2|F1,F2) is based on the characteristics of a noisy process. For example, assuming that the error rate of entering a character is e; If the total length of field values F1 and F2 is m and an edit distance between field values F1, F2 is d then probability Pr(Att1=Att2|F1,F2) can be approximated by, for example:

$$\frac{B ( d : m , e )}{{\sum }_{i = 0}^{d} B ( i : m , e )}$$

where B(i:m,e) is the probability of making i errors when entering m characters with error rate e (this is a binomial distribution). Similarly, B(d:m,e) is the probability of an edit distance d when entering m characters with error rate e.

The edit distance, or the Levenshtein distance, is the minimum number of character addition, deletion, replacement or swap operations needed to transform the string in the first frame into a string in the second frame. For example, the edit distance between “patent” and “patience” is 3, since 3 edits transform one into the other, and there is no way to do it with less than three edits:

0. patent

1. patient (inset of ‘i’ between the first ‘t’ and ‘e’)

2. patienc (substitute ‘c’ for the second ‘t’)

3. patience (insert of ‘e’ at the end)

For a given application a method for record linkage may be limited to determining only duplication scenarios or non-duplication scenarios.

Referring to FIG. 4, for each pair of records, a comparison of a pair of field values is made for each field. The result of such comparison is record difference/similarity such as a distance d (401).

The record difference can be determined by comparing two records field-wise using appropriate similarity metrics. For example, the difference between two last names can be based on edit distance which counts the number of edit operations needed to transform one name string into the other. It should be noted that record comparison can also involve comparing values that belong to different fields. For example, compare a last name in one record against the first name in the other record to account for the error due to confusion of name order. Another example is comparing a home phone number with a work phone number. Thus, record values can be compared field-wise (e.g. a last name with another last name) or across fields (e.g. a last name with a first name, or legal name vs. nick name). There is also freedom to choose suitable similarity metrics. Not only edit distance based metric is permitted but also any reasonable measures for example the soundex metric, the numeric distance, a geographic (spatial) distance for addresses, the distance designed for date/time data.

From the field value comparison, a probability of attribute status is determined 402 based on the distance metric (e.g., edit distances) of the fields.

Attribute status probabilities, determined based on a probability of the status for each attribute, are entered into to the Bayesian net 403. The Bayesian net represents a probabilities model (e.g., conditional probabilities of attribute status given a scenario and prior scenario probabilities).

The probabilities of different scenarios are determined 404. Determining scenario probabilities from the record difference follows the Bayesian logic. That is
Pr(S|a)αPr (o|S).Pr(S)
Where S is a scenario, o is a record difference, Pr(S|o) is the (posterior) probability of scenario S after observing o, Pr(o|S) is the model specifying probability of observing o if S is the true scenario and Pr(S) is the (prior) probability of scenario S (probability assessed before observing the record difference. Sign β reads “proportional to”.

For example, the probabilistic model could be specified as a Bayesian network with a node denoting scenario variable, a node for each field denoting the status of attribute values and a node for each field denoting field value comparison.

The sum of probabilities for different duplication scenarios or non-duplication scenarios yields a probability of overall duplication or non-duplication of the two records 405.

For example, 10 scenarios may be considered, including 5 scenarios of duplication and 5 scenarios of non-duplication. For example, 5 scenarios under which two records present in a database having different attributes correspond to the same object (are duplicative). The probability of each scenario of duplication is determined and summed to determine a total probability of duplication. The sum of the probabilities for all scenarios (duplication and non-duplication) is expected to equal 100%.

Methods for record linkage according to an embodiment of the present disclosure may be applied in any field in which recorded information residing in different places or at different times needs to be brought together. For example, a method for record linkage can be implemented to identify a person having changed their last name or changed their address in various types of files—department of motor vehicle records, insurance claims, and medical records—which include similar identifiers.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

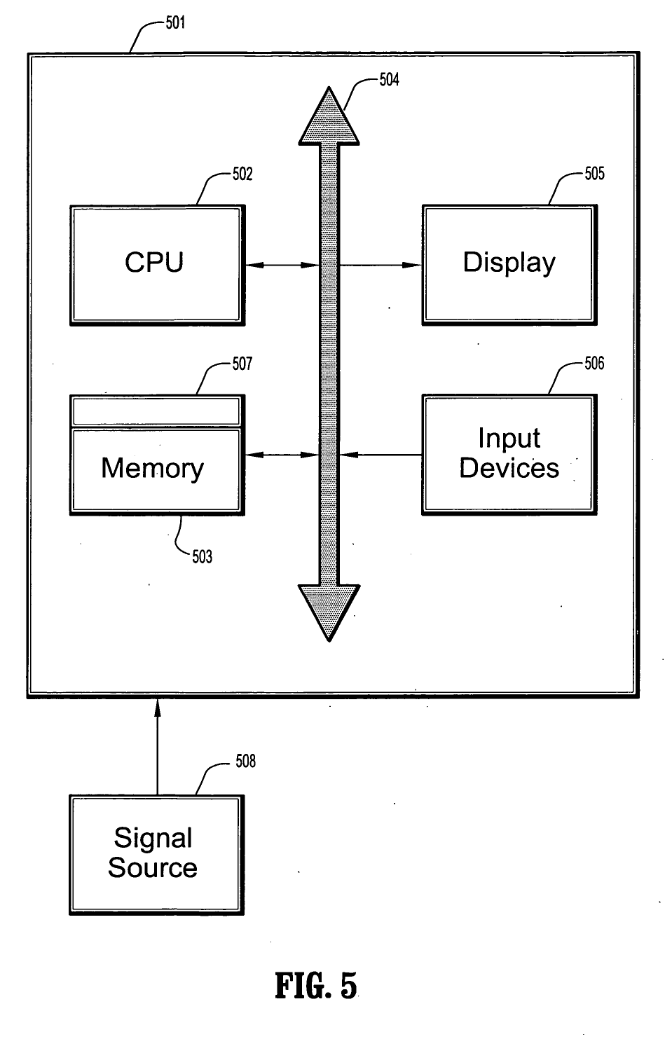

Referring to FIG. 5, according to an embodiment of the present disclosure, a computer system 501 for implementing a method for probabilistic record linkage comprises, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The display 505 can display views of record linkage results, e.g., identifying the location of an item of interest in two or more files. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present invention.

The computer platform 501 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present disclosure provided herein, one of ordinary skill in the related art will be able to contemplate these and similar implementations or configurations of the present invention.

Having described embodiments for a system and method for a probabilistic model for record linkage, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer-implemented method for probabilistic record linkage comprising:
providing a record pair comprising a plurality of fields;
providing a plurality of scenarios, each scenario relating to a distribution of patterns among a plurality of attribute statuses;
comparing the record pair to determine a record difference;
determining a probability of a status for each of a plurality of attributes based on the distance metric of the plurality of fields, wherein each field corresponds to a respective attribute, wherein the field is observable and the attribute is hidden;
determining a probability of each scenario based on the probability of the status for each attribute and the Bayesian net representing the probabilistic model on the relationship between scenarios and attributes; and
outputting a probability of duplication or non-duplication of the record pair determined from the probabilities of the plurality of scenarios.

2. The computer-implemented method of claim 1, wherein comparing the record pair comprises comparing record values of the record pair field-wise or across fields.

3. The computer-implemented method of claim 1, wherein determining the probability of a status for each of the plurality of attributes comprises:
providing a predefined error rate of data entering in a field;
determining a distance metric between field values; and
determining a probability of making i errors when entering m characters with the predefined error rate.

4. The computer-implemented method of claim 1, wherein each among a plurality of scenarios is characterized by a probability model on patterns of attribute statuses for example Bayesian net, conditional probabilities of attribute status given scenarios.

5. The computer-implemented method of claim 1,
wherein the probability of duplication is compared to a threshold, wherein the threshold corresponds to a significant probability of duplication.

6. The computer-implemented method of claim 1, further comprising:
providing a graphical user interface; and
displaying at least one of a scenario probability, a most probable scenario, a probability of duplication, and/or a probability that an entity is intended by an input search criteria.

7. The computer-implemented method of claim 1, wherein the record pair is a search criteria for determining a target and a plurality of database records, the method further comprising:
determining for each database record the probability of duplication or non-duplication as a probability that the record is the target of the search criteria; and
displaying in a graphical user interface the database records and a corresponding probability.

8. The computer-implemented method of claim 1, wherein the record pair is a search criteria for determining a target and a plurality of database records, the method further comprising:
determining for each database record the probability of duplication or non-duplication as a confidence score corresponding to the search criteria; and
displaying in a graphical user interface each database records and a corresponding confidence score.

9. A computer-implemented method comprising:
receiving a record pair; and
outputting a probability of duplication between the record pair from an observation of field values of the record pair and noisy characteristics of the record pair.

10. The computer-implemented method of claim 9, wherein the observation of field values is one of an edit distance, a soundex distance, a numerical distance, or a date distance between a pair of fields corresponding to the record pair, respectively.

11. The computer-implemented method of claim 9, further comprising modeling the noisy characteristics of the record pair comprising:
determining a probability of a difference between attribute values corresponding to the fields; and
determining a probability of an error in the field values.

12. A program storage device readable by machine, tangibly embodying a program of instructions executable by the machine to perform method steps for probabilistic record linkage, the method steps comprising:
providing a record pair comprising a plurality of fields;
providing a plurality of scenarios, each scenario relating to a distribution of patterns among a plurality of attribute statuses;
comparing the record pair to determine a record difference;
determining a probability of a status for each of a plurality of attributes based on the distance metric of the plurality of fields, wherein each field corresponds to a respective attribute, wherein the field is observable and the attribute is hidden;
determining a probability of each scenario based on the probability of the status for each attribute and the Bayesian net representing the probabilistic model on the relationship between scenarios and attributes; and
outputting a probability of duplication or non-duplication of the record pair determined from the probabilities of the plurality of scenarios.

13. The method of claim 12, wherein comparing the record pair comprises comparing record values of the record pair field-wise or across fields.

14. The method of claim 12, wherein determining the probability of a status for each of the plurality of attributes comprises:
providing a predefined error rate of data entering in a field;
determining a distance metric between field values; and
determining a probability of making i errors when entering m characters with the predefined error rate.

15. The method of claim 12, wherein each among a plurality of scenarios is characterized by a probability model on patterns of attribute statuses for example Bayesian net, conditional probabilities of attribute status given scenarios.

16. The method of claim 12, wherein the probability of duplication is compared to a threshold, wherein the threshold corresponds to a significant probability of duplication.

17. The method of claim 12, further comprising:
providing a graphical user interface; and
displaying at least one of a scenario probability, a most probable scenario, a probability of duplication, and/or a probability that an entity is intended by an input search criteria.

18. The method of claim 12, wherein the record pair is a search criteria for determining a target and a plurality of database records, the method further comprising:
determining for each database record the probability of duplication or non-duplication as a probability that the record is the target of the search criteria; and
displaying in a graphical user interface the database records and a corresponding probability.

19. The method of claim 11, wherein the record pair is a search criteria for determining a target and a plurality of database records, the method further comprising:
determining for each database record the probability of duplication or non-duplication as a confidence score corresponding to the search criteria; and
displaying in a graphical user interface each database records and a corresponding confidence score.
